(19) United States
(12) Patent Application Publication
(10) Pub. No.: US 2022/0179093 A1
(43) Pub. Date: Jun. 9, 2022

(54) ADJUSTMENT DEVICE AND LIDAR MEASURING DEVICE

(71) Applicant: Ibeo Automotive Systems GmbH, Hamburg (DE)

(72) Inventors: Ralf Beuschel, Friedrichshafen (DE); Falko Diebel, Hamburg (DE); Michael Köhler, Hamburg (DE)

(21) Appl. No.: 17/567,027

(22) Filed: Dec. 31, 2021

Related U.S. Application Data
(63) Continuation of application No. PCT/EP2020/067142, filed on Jun. 19, 2020.

(30) Foreign Application Priority Data
Jul. 2, 2019 (DE) 102019209691.3

(51) Int. Cl. G01S 17/931; G01S 7/481

(52) U.S. Cl. CPC G01S 17/931; G01S 7/4815

(57) ABSTRACT

An adjustment device for adjusting a detection process of a Lidar measuring device in a focal plane array arrangement on a vehicle, with: an input interface for receiving a setting with information about at least two vertical acquisition zones; a setting unit for determining a control parameter of a detection process for each of the at least two acquisition zones (E₁-E₄) based upon the received setting; a selection unit for determining a partial quantity of rows running parallel to a longitudinal plane of the vehicle of transmitting elements of a Lidar transmitting unit of the Lidar measuring device and/or sensor elements of a Lidar receiving unit of the Lidar measuring device for each of the at least two acquisition zones based upon the received setting; and a control unit for controlling the Lidar measuring device, wherein the determined partial quantity of rows is controlled for each acquisition zone based upon the determined control parameter, so as to detect objects within the at least two acquisition zones. The present invention further relates to a Lidar measuring device as well as to a method for adjusting a detection process of a Lidar measuring device in a focal plane array arrangement on a vehicle.

### CROSS REFERENCE TO RELATED APPLICATIONS

This application is a continuation of International Application No.: PCT/EP2020/067142, filed on Jun. 19, 2020, which claims priority from German Patent Application No. 102019209691.3, filed on Jul. 2, 2019, the contents of each of which are incorporated by reference herein

### FIELD OF THE INVENTION

The present invention relates to an adjustment device for adjusting a detection process of a Lidar measuring device in a focal plane array arrangement on a vehicle. The present invention further relates to a Lidar measuring device in a focal plane array arrangement for detecting objects in an environment of a vehicle, as well as to a method for adjusting a detection process of a Lidar measuring device.

### BACKGROUND

Modern vehicles (automobiles, transporters, trucks, motorcycles, driverless transport systems, etc.) comprise a plurality of systems that provide a driver or operator with information and/or partially or fully automatedly control individual functions of the vehicle. Sensors acquire the environment of the vehicle along with other possible road users. Based upon the acquired data, a model of the vehicle environment can then be generated, and changes in this vehicle environment can be reacted to. Continued development in the field of autonomously and partially autonomously driving vehicles is leading to an ever growing influence and sphere of action with respect to driver assistance systems (advanced driver assistance systems, ADAS) and autonomously operating transport systems. The development of ever more precise sensors is making it possible to acquire the environment and completely or partially control individual functions of the vehicle without any intervention by the driver.

Lidar (light detection and ranging) technology here constitutes one important sensor principle for acquiring the environment. A Lidar sensor is based upon transmitting light pulses and detecting the reflected light. A distance to the place of reflection can be calculated by means of a runtime measurement. A target can be detected by evaluating the received reflections. With regard to the technical implementation of the corresponding sensor, a distinction is made between scanning systems, which most often function based upon micromirrors, and non-scanning systems, in which several transmitting and receiving elements are statically arranged one next to the other (in particular so-called focal plane array arrangement).

In this conjunction, WO 2017/081294 A1 describes a method and a device for optical distance measurement. The use of a transmitting matrix for transmitting measuring pulses and a receiving matrix for receiving the measuring pulses are described. When transmitting the measuring pulses, subsets of the transmitting elements of the transmitting matrix are activated.

One challenge when detecting objects by means of a Lidar lies in the wide variety of objects to be detected and their varying properties with respect to the reflection of laser pulses. Dark objects, for example such as tires, are harder to detect than brighter objects, for example such as bridge piers or roadway borders. Since there is a plurality of various objects in the area of vehicle applications that are all to be detected, suitable Lidar measuring devices must be designed in an appropriate manner. On the one hand, the power can be increased to ensure detections with an adequate reliability. On the other hand, an updating rate can possibly be reduced to enable more detections per unit time.

### SUMMARY

Proceeding from the above, the object of the present invention is to provide an approach toward better detecting objects in a visual field of a Lidar measuring device. In particular, the most reliable detection possible of objects with varying properties is to be achieved. The energy consumption is here to be kept as low as possible. In addition, a cost-effective realization of the Lidar measuring device is to be enabled.

In order to achieve this object, the invention in a first aspect relates to an adjustment device for adjusting a detection process of a Lidar measuring device in a focal plane array arrangement on a vehicle, with:

an input interface for receiving a setting with information about at least two vertical acquisition zones;

a setting unit for determining a control parameter of a detection process for each of the at least two acquisition zones based upon the received setting;

a selection unit for determining a partial quantity of rows running parallel to a longitudinal plane of the vehicle of transmitting elements of a Lidar transmitting unit of the Lidar measuring device and/or sensor elements of a Lidar receiving unit of the Lidar measuring device for each of the at least two acquisition zones based upon the received setting; and

a control unit for controlling the Lidar measuring device, wherein the determined partial quantity of rows is controlled for each acquisition zone based upon the determined control parameters, so as to detect objects within the at least two acquisition zones.

interface for activating the selection of rows of transmitting elements of the Lidar transmitting unit and/or sensor elements of the Lidar receiving unit of the Lidar measuring device, so as to detect objects within the object detection area.

In another aspect, the present invention relates to a Lidar measuring device in a focal plane array arrangement for detecting objects in an environment of a vehicle, with:

a Lidar transmitting unit with a plurality of transmitting elements for transmitting light pulses and a Lidar receiving unit with a plurality of sensor elements for receiving the light pulses, wherein the transmitting elements and the sensor elements are arranged in rows that run parallel to a longitudinal plane of the vehicle; and an adjustment device as defined above.

Additional aspects of the invention relate to a method configured according to the adjustment device and a computer program product with program code for implementing the steps of the method when the program code is run on a computer, as well as a storage medium that stores a computer program, which when run on a computer causes the method described herein to be implemented.

The invention provides that a distinction be made between at least two vertical acquisition zones. A vertical acquisition zone is here understood as a vertical section or area of the visual field. A visual field of the Lidar measuring device is divided into several acquisition zones. In the adjustment device according to the invention, a control parameter is now determined for each of these acquisition zones. In addition, a partial quantity of rows of transmitting elements and/or sensor elements that run parallel to a horizontal plane of the vehicle is determined for each of these acquisition zones. The respective partial quantity of rows is then separately controlled via a control unit. In other words, then, varying parameters are set for varying portions of the visual field. The row-by-row controllable Lidar transmitting unit or the row-by-row readable Lidar receiving unit is controlled in such a way that rows of varying receiving zones are handled in a different manner.

This results in an improved detection of objects. In a vehicle, the upper rows of transmitting or sensor elements at least partially also acquire the sky as well as objects above the roadway, such as bridges, ceilings, etc. The lower rows of transmitting and/or sensor elements acquire the roadway. Varying objects are to be expected in these different areas or acquisition zones. In addition, varying distances are especially relevant. For example, a black tire may be lying on the roadway, whereas it would not be expected to be in the sky. By differentiating and individually establishing control parameters according to the invention for at least two vertical acquisition zones, this type of model knowledge can be considered and made useful for object detection. The Lidar measuring device is operated in such a way as to adjust the properties of the Lidar transmitting unit or Lidar receiving unit for varying vertical acquisition zones to the objects expected in these acquisition zones. Reliability during object detection can thereby be improved. Additionally or alternatively, it becomes possible to use a cost-effective sensor with the same reliability. Advantages likewise arise with regard to the required power and with regard to the required installation space.

In a preferred embodiment, the input interface is configured to receive a height of a horizontal line in relation to an alignment and position of the Lidar measuring device on the vehicle. The selection unit is configured to determine a first partial quantity of rows that are allocated to an area above the horizontal line, and a second partial quantity of rows that are allocated to an area below the horizontal line. In particular, it is expedient to differentiate two acquisition zones on a horizontal line. Primarily the roadway as well as objects in the area of the roadway will be expected below the horizontal line. Primarily objects that span the roadway will be expected above the horizontal line. Objects that span the roadway are normally comparatively bright. Objects lying on the roadway can also be dark. Varying coverage ranges are also relevant. Properties can be adjusted accordingly during detection. An improved reliability results.

In a preferred embodiment, the input interface is configured to receive an overall time budget of a measuring process. The setting unit is configured to determine a control parameter with a portion of the overall time budget for each acquisition zone. In particular, a specific overall time budget available for performing an individual measuring process can be prescribed for a Lidar measuring device. For example, such an overall time budget arises proceeding from the desired or required measuring frequency (updating rate), or also proceeding from the hardware implementation. A prescribed overall time budget is distributed in an adjusted manner to the different adjustment zones.

In another preferred embodiment, the input interface is configured to receive an overall power budget of a measuring process. The setting unit is configured to determine a control parameter with a portion of the overall power budget for each acquisition zone. Comparably to the stipulated overall time budget described above, an overall power budget can also be prescribed. This power is divided among the varying acquisition zones in such a way that the objects to be expected in this acquisition zone can be detected as reliably as possible.

In a preferred embodiment, the adjustment device is configured to adjust the detection process during a commissioning of the Lidar measuring device. The adjustment device according to the invention is used to adjust the detection process of the Lidar measuring device. In this regard, the input interface as well as the setting unit and selection unit perform their function once during the commissioning of the Lidar measuring device, whereas the control unit performs its respective function during a measuring process, i.e., during operation.

In another preferred embodiment, the input interface is configured to receive a setting with information about a vertical expansion of four vertical acquisition zones. A first acquisition zone corresponds to an area of the sky. A second acquisition zone below the first acquisition zone corresponds to a distant viewing area. A third acquisition zone below the second acquisition zone corresponds to a medium roadway area. A fourth acquisition zone below the third acquisition zone corresponds to a near roadway area. Using a total of four acquisition zones adjusts the behavior of the detection process in several areas to the respective objects to be expected in this area. This makes it possible to improve reliability.

In another preferred embodiment, the Lidar measuring device is configured to perform a time correlated single photon counting (TCSPC) measuring process. The setting unit is configured to determine a number of TCSPC integrations. A number of TCSPC integrations is preferably determined in the setting unit as the control parameter. If a higher number of TCSPC integrations is used in an acquisition zone, an improved object detection can be achieved within this acquisition zone. In particular, dark and/or more remote objects can also be detected.

In a preferred embodiment of the Lidar measuring device, the Lidar measuring device is configured to be fastened to a vehicle in an area of a bumper of the vehicle. For example, the Lidar measuring device can be integrated into a bumper of the vehicle. This results in a clear view of objects in front or back of the vehicle. Differentiating between various acquisition zones is particularly advantageous, since a clear view results for the Lidar measuring device.

In a preferred embodiment of the Lidar measuring device, the Lidar transmitting unit and Lidar receiving unit have a vertical visual field of 12 degrees to 20 degrees, preferably of 16 degrees. A visual field center of the vertical visual field preferably runs parallel to a longitudinal plane of the vehicle. A larger visual field is divided into varying acquisition zones.

Let it be understood that a concrete parameter and a concrete allocation, in particular a number of TCSPC integrations as well as an indication of rows for different acquisition zones (an allocation of rows to acquisition zones), can also be directly received via the input interface. The setting unit and the selection unit then essentially act to forward the corresponding information to the control unit, so to speak. For example, the setting unit thus forwards the number of TCSPC integrations for the respective acquisition zone as control parameters. The selection unit forwards the partial quantities to acquisition zones proceeding from the received allocation of rows.

A detection process corresponds to a transmitting process of the Lidar transmitting unit and a corresponding readout over a prescribed duration of the Lidar receiving unit. A vertical acquisition zone corresponds to a part of the visual field of the Lidar measuring device. A focal plane array arrangement is understood as a configuration of sensor elements (or transmitting elements) in essentially one plane. In particular, a Lidar receiving unit is a microchip with corresponding sensor elements. In particular, a Lidar transmitting unit is likewise a microchip with corresponding transmitting elements. The receiving and transmitting unit can be arranged together on a microchip. For example, the transmitting and sensor elements are each arranged on a chip in a matrix form, and distributed over a surface of the chip. One or several sensor elements are allocated to a transmitting element. In particular, a light pulse of a Lidar transmitting unit is understood as a pulse of laser light. In particular, an environment of a vehicle comprises an area in the environment of the vehicle that is visible from the vehicle. The longitudinal plane of a vehicle is aligned parallel to a longitudinal and transverse axis of the vehicle.

Preferred embodiments of the invention are described in the dependent claims. Let it be understood that the features mentioned above and still to be explained below can be used not only in the respectively indicated combination, but also in other combinations or taken separately, without departing from the framework of the present invention. In particular, the adjustment device, the Lidar measuring device as well as the method and the computer program product can be configured according to the embodiments described in the dependent claims for the adjustment device or Lidar measuring device.

### BRIEF DESCRIPTION OF THE DRAWINGS

The invention will be described and explained in more detail below based upon several selected exemplary embodiments in conjunction with the attached drawings. Shown on:

FIG. 1 is a schematic view of a Lidar measuring device according to one aspect of the present invention;

FIG. 2 is a schematic view of an adjustment unit according to the invention;

FIG. 3 is a schematic view of an adjustment device with four vertical acquisition zones;

FIG. 4 is a schematic view of a Lidar transmitting unit; and

FIG. 5 is a schematic view of a method according to the invention.

### DETAILED DESCRIPTION OF THE PREFERRED EMBODIMENTS

Schematically depicted on FIG. 1 is a Lidar measuring device 10 according to the invention for detecting an object 12 in an environment of a vehicle 14. In the exemplary embodiment shown, the Lidar measuring device 10 is integrated into the vehicle 14. For example, the object 12 in the environment of the vehicle 14 can be another vehicle or also a static object (traffic sign, house, tree, etc.) or another road user (pedestrian, bicyclist, etc.). The Lidar measuring device 10 is preferably mounted in the area of a bumper of the vehicle 14, and can in particular evaluate the environment of the vehicle 14 in front of the vehicle. For example, the Lidar measuring device 10 can be integrated into the front bumper.

The Lidar measuring device 10 according to the invention comprises a Lidar receiving unit 16 as well as a Lidar transmitting unit 18. The Lidar measuring device 10 further comprises an adjusting device 20 for adjusting a visual field of the Lidar measuring device 10.

Both the Lidar receiving unit 16 and the Lidar transmitting unit 18 are preferably configured in a focal plane array configuration. The elements of the respective device are essentially arranged in a plane on a corresponding chip. The chip of the Lidar receiving unit or the Lidar transmitting unit is arranged in a focal point of a corresponding optical system (transmitting optics or receiving optics). In particular, sensor elements of the Lidar receiving unit 16 or transmitting elements of the Lidar transmitting unit 18 are arranged in the focal point of the respective receiving or transmitting optics. For example, these optics can consist of an optical lens system.

The sensor elements of the Lidar receiving unit 16 are preferably configured as a SPAD (single photon avalanche diode). The Lidar transmitting unit 18 comprises several transmitting elements or transmitting laser light or laser pulses. The transmitting elements are preferably configured as a VCSEL (vertical cavity surface emitting laser). The transmitting elements of the Lidar transmitting unit 18 are distributed over a surface of a transmitting chip. The sensor elements of the Lidar receiving unit 16 are distributed over a surface of the receiving chip.

The transmitting chip has allotted to it transmitting optics, and the receiving chip has allotted to it receiving optics. The optics image the incoming light from an area of the room on the respective chip. The room area corresponds to the visual area of the Lidar measuring device 10, which is examined or sensed for objects 12. The room area of the Lidar receiving unit 16 or the Lidar transmitting unit 18 is essentially identical. The transmitting optics image a transmitting element onto a spatial angle that represents a partial area of the room area. The transmitting element sends laser light out into this spatial angle accordingly. The transmitting elements together cover the entire room area. The receiving optics image a sensor element onto a spatial angle that represents a partial area of the room area. The number of all sensor elements covers the entire room area. Transmitting elements and sensor elements that examine the same spatial angle image onto each other, and are accordingly allotted or allocated to each other. In normal cases, a laser light of a transmitting element is always imaged onto the accompanying sensor element. It is favorable that several sensor elements be arranged inside of the spatial angle of a transmitting element.

In order to determine or detect objects 12 inside of the room area, the Lidar measuring device 10 performs a measuring process. Such a measuring process comprises one or several measuring cycles, depending on the structural design of the measuring system and its electronics. A TCSPC (time correlated single photon counting) method is here preferably used in the control unit 20. Individual incoming photons are here detected, in particular via an SPAD, and the time at which the sensor element is triggered (detection time) is stored in a memory element. The detection time is correlated with a reference time at which the laser light is transmitted. The difference can be used to ascertain the runtime of the laser light, from which the distance of the object 12 can be determined.

A sensor element of the Lidar receiving unit 16 can be triggered by the laser light on the one hand, and by background radiation on the other. At a specific distance of the object 12, a laser light always arrives at the same time, whereas the background radiation provides the same probability of triggering a sensor element at any time. When a measurement is performed multiple times, in particular in several measuring cycles, the triggerings of the sensor element add up at the detection time that corresponds to the runtime of the laser light in relation to the distance of the object. By contrast, triggerings caused by the background radiation are uniformly distributed over the measuring duration of a measuring cycle. One measurement corresponds to the transmission and subsequent detection of the laser light. The data from the individual measuring cycles of a measuring process stored in the memory element make it possible to evaluate the detection times that were determined several times, so as to infer the distance of the object 12.

A sensor element is favorably connected with a TDC (time to digital converter). The TDC stores the time at which the sensor element was triggered in the memory element. For example, such a memory element can be configured as a short-term memory or a long-term memory. The TDC fills a memory element with the times at which the sensor elements detect an incoming photon for a measuring process. This can be graphically depicted by a histogram, which is based upon the data of the memory element. In a histogram, the duration of a measuring cycle is divided into very short time segments (so-called bins). If a sensor element is triggered, the TDC increases the value of a bin by 1. The bin corresponding to the runtime of the laser pulse is filled, meaning the difference between the detection time and reference time.

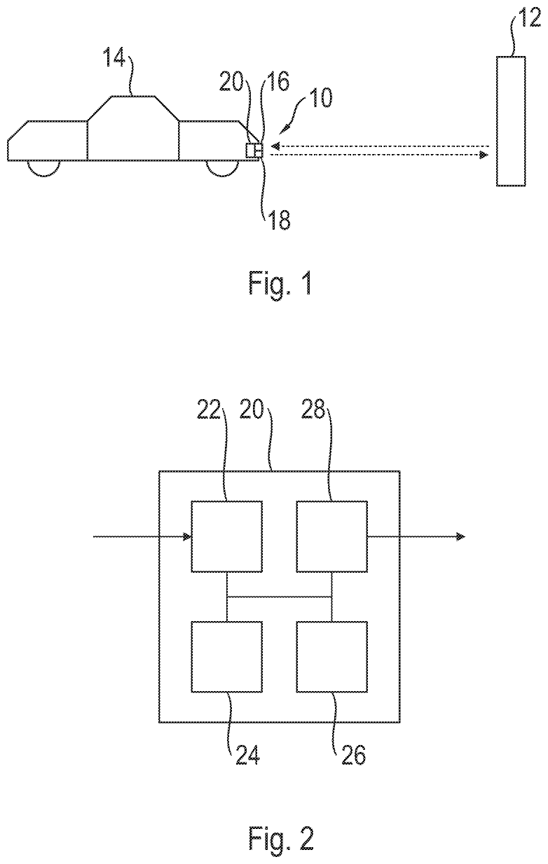

FIG. 2 schematically depicts an adjustment device according to the invention for adjusting a detection process of a Lidar measuring device in a focal plane array arrangement in a vehicle. The adjustment device 20 comprises an input interface 22, a setting unit 24, a selection unit 26 as well as a control unit 28. The various units and interfaces can be configured or implemented in software and/or hardware, whether individually or combined. In particular, the units can be implemented in software run on a processor of the Lidar measuring device.

A setting is received via the input interface 22. The setting comprises information about at least two vertical acquisition zones. In particular, the setting can already comprise an allocation between rows of transmitting elements and/or sensor elements to acquisition zones, as well as a respective indication of a power and/or a number of integration processes for each acquisition zone. However, it is also possible for the setting to comprise other information, based upon which a control parameter as well as a partial quantity of rows for each of the acquisition zones can be determined. For example, the setting can be an indication of a current environment of the vehicle. The Lidar measuring device can also be actuated according to the invention based upon a current traffic situation. A different setting is used on a highway than on a country road or in city traffic. The traffic situation in which the vehicle finds itself (i.e., the setting) can be determined based upon environmental sensors, map material, a user input or other information sources. In particular, an overall power budget and/or an overall time budget can be received as the setting. This overall budget can then be divided among the various acquisition zones in the setting unit 24 as well as in the selection unit 26.

A control parameter of a detection process is determined for each acquisition zone in the setting unit 24. In particular, the control parameter can comprise a number of TCSPC integration processes. For example, such a number can be determined based upon a prescribed overall number of possible TCSPC integration processes (overall time budget). The control parameter allows a control of the Lidar measuring device, and prescribes properties of the measuring process. In particular, a separate control parameter is determined for each of the acquisition zones. In this regard, each acquisition zone is operated with different properties.

A partial quantity of rows of transmitting elements and/or sensor elements is determined in the selection unit 26. To this end, the received setting is evaluated. It is determined which rows of the Lidar chips arranged in rows are or are to be allocated to the respective acquisition zones. If prescribed rows were already received as the setting, the latter can be directly forwarded in the selection unit 26. It is likewise possible for the partial quantity of rows to be determined based upon a setting that comprises an indication of the zone sizes on an absolute or relative scale.

The Lidar measuring device is controlled via the control unit 28. In particular, the allocated partial quantity of rows is separately controlled for each acquisition zone based upon the corresponding control parameter. As a result, the Lidar measuring device is operated in such a way as to detect objects within the acquisition zones with varying parameters. In particular, it becomes possible to detect objects in varying zones with respective properties tailored to these zones.

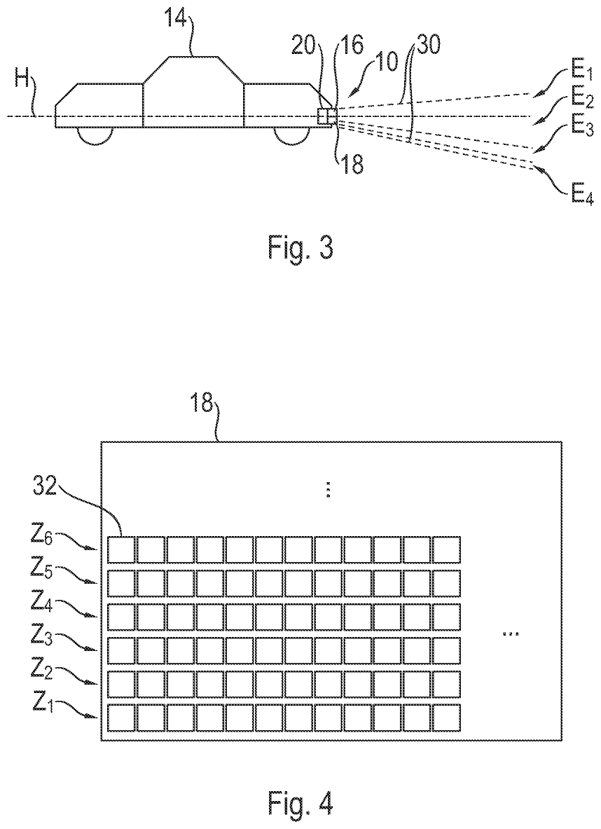

Schematically depicted on FIG. 3 is a side view of a vehicle 14, in which is arranged a Lidar measuring device 10 with an adjustment device 20, a Lidar receiving unit 16 and a Lidar transmitting unit 18 in the area of the bumper. In the exemplary embodiment shown, the vertical visual field 30 of the Lidar measuring device is divided into a total of four different acquisition zones E₁-E₄. Separate control parameters are established or used in each of these acquisition zones E₁-E₄. For example, the vertical visual field can have an opening angle of 16 degrees. Assuming that the Lidar transmitting unit comprises 80 rows of transmitting elements in all, for example, lines 0 to 14 can be allocated to the first acquisition zone E₁, lines 15 to 64 to the second acquisition zone E₂, lines 65 to 74 to the third acquisition zone E₃ and lines 75 to 79 to the fourth acquisition zone E₄. As shown in the exemplary embodiment depicted, the boundary between the first acquisition zone E₁ and the second acquisition zone E₂ runs on a horizontal plane H, which in the depicted exemplary embodiment corresponds to a longitudinal plane of the vehicle 14. The first acquisition zone E₁ then corresponds to an area of the sky above the horizontal line. While a large range is required in this first acquisition zone, it is improbable that dark objects will arise.

In the depicted exemplary embodiment, for example, a budget of 235 TCSPC integrations can be provided in this area. A remote area is acquired in the second acquisition zone E₂. In this area, it is very relevant that dark objects be detectable as well, for example so that tires lying on the street can be acquired. For this reason, a higher number of TCSPC integrations are used in this area, for example 355. A medium roadway area is acquired in the third acquisition zone E₃, i.e., a roadway area at a medium distance. For example, the medium area corresponds to a distance of up to 29 meters. For example, a number of 262 TCSPC integrations can be established in this area via the control parameter. A near roadway area is evaluated in the fourth acquisition zone E₄, i.e., an area immediately in front of the vehicle, for example up to a distance of 10 meters. Because this area is nearby and it may no longer be possible to react to potential obstacles, a lower number of TCSPC integrations is sufficient. For example, 222 TCSPC integrations can be used. As a whole, then, the TCSPC integrations are each allocated to the expected object properties in the corresponding acquisition zone.

Schematically shown on FIG. 4 is a Lidar transmitting unit 18 according to the invention. The Lidar transmitting unit 18 comprises a plurality of transmitting elements 32, which are arranged in a plurality of rows Z₁-Z₆. For reasons of clarity, the drawing depicts only a few lines or a selection of transmitting elements 32. For example, the Lidar transmitting unit 18 can comprise an array with 80*128 transmitting elements 32. A corresponding sensor element of the Lidar receiving unit is allocated to each transmitting element 32. A sensor element can here also describe a microcell with several individual SPAD cells. The transmitting elements 32 can be activated row by row. This means that all transmitting elements 32 arranged in the same row Z₁-Z₆ can be activated simultaneously.

Because the Lidar transmitting unit 18 is configured in a focal plane array arrangement and fixedly connected with the vehicle or built into the vehicle, the alignment of the arrays of the Lidar transmitting unit 18 relative to the vehicle cannot be changed during operation. The allocation of the acquisition zones to the various rows of transmitting and/or sensor elements can thus also already be prescribed during a commissioning of the sensor. An adjustment to the runtime is likewise conceivable. According to the invention, rows allocated to a specific acquisition zone are operated with varying control parameters. As a result, objects within the acquisition zones can be acquired in an optimized manner.

Let it be understood that the Lidar receiving unit with sensor elements is configured correspondingly to the Lidar transmitting unit 18. The Lidar transmitting unit 18 and the Lidar receiving unit 16 are usually fixedly connected with each other, and preferably arranged one next to the other, when the vehicle performs a movement. Analogously to actuating the transmitting elements 32 of the Lidar transmitting unit 18, the sensor elements of the Lidar receiving unit 16 can also be read out row by row.

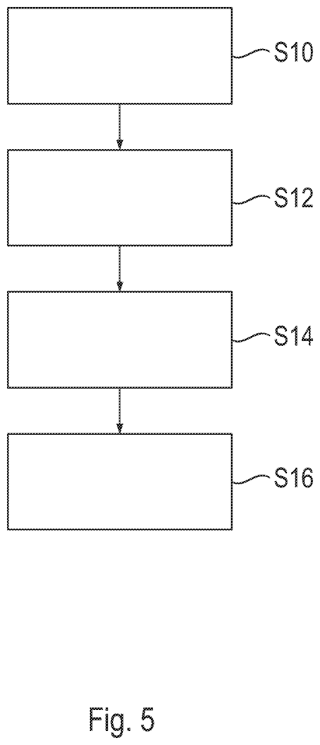

FIG. 5 schematically depicts a method according to the invention for adjusting a detection process of a Lidar measuring device in a focal plane array arrangement on a vehicle. The method comprises the steps of receiving S10 a setting, determining S12 a control parameter, determining S14 a partial quantity of parallel running rows of transmitting elements and/or sensor elements, and actuating S16 the Lidar measuring device. For example, the method can be implemented in software that is run on a processor of a Lidar measuring device.

The invention was comprehensively described and explained based upon the drawings and the specification. The specification and explanation are to be construed as an example, and not as limiting. The invention is not limited to the disclosed embodiments. Other embodiments or variations arise for the expert during the use of the present invention as well as during a precise analysis of the drawings, the disclosure, and the following claims.

In the claims, the words “comprise” and “with” do not rule out the presence of additional elements or steps. The undefined article “a” or “an” does not preclude the presence of a plurality. A single element or a single unit can perform the functions of several units mentioned in the claims. An element, a unit, an interface, a device, and a system can be partially or completely converted into hardware and/or software. The mere mention of several measures in several different dependent claims must not be taken to mean that advantageous use could likewise not be made of a combination of these measures. Reference numbers in the claims are not to be understood as limiting.

1. An adjustment device for adjusting a detection process of a Lidar measuring device in a focal plane array arrangement on a vehicle, with:
an input interface for receiving a setting with information about at least two vertical acquisition zones;
a setting unit for determining a control parameter of a detection process for each of the at least two acquisition zones (E₁-E₄) based upon the received setting;
a selection unit for determining a partial quantity of rows running parallel to a longitudinal plane of the vehicle of transmitting elements of a Lidar transmitting unit of the Lidar measuring device and/or sensor elements of a Lidar receiving unit of the Lidar measuring device for each of the at least two acquisition zones based upon the received setting; and
a control unit for controlling the Lidar measuring device, wherein the determined partial quantity of rows is actuated for each acquisition zone based upon the determined control parameter, so as to detect objects within the at least two acquisition zones.

2. The adjustment device according to claim 1, wherein
the input interface is configured to receive a height of a horizontal line (H) in relation to an alignment and position of the Lidar measuring device on the vehicle; and
the selection unit is configured to determine a first partial quantity of rows that are allocated to an area above the horizontal line, and a second partial quantity of rows that are allocated to an area below the horizontal line.

3. The adjustment device according to claim 1, wherein
the input interface is configured to receive an overall time budget of a measuring process; and
the setting unit is configured to determine a control parameter with a portion of the overall time budget for each acquisition zone (E₁-E₄).

4. The adjustment device according to claim 1, wherein
the input interface is configured to receive an overall power budget of a measuring process; and
the setting unit is configured to determine a control parameter with a portion of the overall power budget for each acquisition zone (E₁-E₄).

5. The adjustment device according to claim 1, wherein the adjustment device is configured to adjust the detection process during a commissioning of the Lidar measuring device (10).

6. The adjustment device according to claim 1, wherein the input interface is configured to receive a setting with information about a vertical expansion of four vertical acquisition zones (E₁-E₄);
a first acquisition zone corresponds to an area of the sky, a second acquisition zone below the first acquisition zone corresponds to a distant viewing area, a third acquisition zone below the second acquisition zone corresponds to a medium roadway area, and a fourth acquisition zone below the third acquisition zone corresponds to a near roadway area

7. The adjustment device according to claim 1, wherein the Lidar measuring device is configured to perform a time correlated single photon counting (TCSPC) measuring process; and
the setting unit is configured to determine a number of TCSPC integrations.

8. A Lidar measuring device in a focal plane array arrangement for detecting objects in an environment of a vehicle, with:
a Lidar transmitting unit with a plurality of transmitting elements for transmitting light pulses and a Lidar receiving unit with a plurality of sensor elements for receiving the light pulses, wherein the transmitting elements and the sensor elements are arranged in rows that run parallel to a longitudinal plane of the vehicle; and
an adjustment device for adjusting a detection process of a Lidar measuring device in a focal plane array arrangement on a vehicle, with:
an input interface for receiving a setting with information about at least two vertical acquisition zones;
a setting unit for determining a control parameter of a detection process for each of the at least two acquisition zones (E₁-E₄) based upon the received setting;
a selection unit for determining a partial quantity of rows running parallel to a longitudinal plane of the vehicle of transmitting elements of a Lidar transmitting unit of the Lidar measuring device and/or sensor elements of a Lidar receiving unit of the Lidar measuring device for each of the at least two acquisition zones based upon the received setting; and
a control unit for controlling the Lidar measuring device, wherein the determined partial quantity of rows is actuated for each acquisition zone based upon the determined control parameter, so as to detect objects within the at least two acquisition zones.

9. The Lidar measuring device according to claim 8, wherein the Lidar measuring device is configured for attachment to a vehicle in an area of a bumper of the vehicle.

10. The Lidar measuring device according to claim 8, wherein the Lidar transmitting unit and the Lidar receiving unit have a vertical visual field of 12° to 20°, preferably 16°; and
a visual field center of the vertical visual field preferably runs parallel to the longitudinal plane of the vehicle.

11. A method for adjusting a detection process of a Lidar measuring device in a focal plane array arrangement on a vehicle, with the following steps:
receiving (S10) a setting with information about at least two vertical acquisition zones (E₁-E₄);
determining (S12) a control parameter of a detection process for each of the at least two acquisition zones based upon the received setting;
determining (S14) a partial quantity of rows running parallel to a longitudinal plane of the vehicle of transmitting elements of a Lidar transmitting unit of the Lidar measuring device and/or sensor elements of a Lidar receiving unit of the Lidar measuring device for each of the at least two acquisition zones based upon the received setting; and
controlling (S16) the Lidar measuring device, wherein the determined partial quantity of rows is controlled for each acquisition zone based upon the determined control parameters, so as to detect objects within the at least two acquisition zones.

12. A computer program product with program code for performing the steps of the method according to claim 11 if the program code is run on a computer.
